(19) United States
(12) Patent Application Publication
(10) Pub. No.: US 2020/0226064 A1
(43) Pub. Date: Jul. 16, 2020

(54) METHOD OF REVERSE MAPPING AND DATA CONSOLIDATION TO ENHANCE RANDOM PERFORMANCE

(71) Applicant: Western Digital Technologies, Inc., San Jose, CA (US)

(72) Inventors: Ramkumar Ramamurthy, San Jose, CA (US); Ramanathan Muthiah, San Jose, CA (US)

(73) Assignee: Western Digital Technologies, Inc., San Jose, CA (US)

(21) Appl. No.: 16/247,977

(22) Filed: Jan. 15, 2019

(51) Int. Cl. G06F 12/02; G06F 12/1036; G06F 12/06

(52) U.S. Cl. CPC G06F 12/0292; G06F 12/06; G06F 12/0246; G06F 12/1036

(57) ABSTRACT

A method for data consolidation in a memory system includes selecting a source block for data consolidation from a plurality of memory blocks in the memory system. The method further includes reading a physical-to-logical address mapping table associated with the source block to determine a first logical group in the source block. The method further includes loading a first logical-to-physical address mapping table associated with the first logical group. The method further includes identifying, using the first logical-to-physical address mapping table, valid memory fragments of the source block that are associated with the first logical group. The method further includes consolidating the identified valid memory fragments associated with the first logical group.

### TECHNICAL FIELD

This disclosure relates to memory systems, and in particular to methods and systems of reverse mapping and data consolidation to enhance random performance.

### BACKGROUND

Non-volatile memory systems provide a type of computer memory that retains stored information without requiring an external power source. One type of non-volatile memory, flash memory, is widely used in various computing devices and in stand-alone memory devices. For example, flash memory can be found in laptops, digital audio player, digital cameras, smart phones, video games, scientific instruments, industrial robots, medical electronics, solid state drives, USB drives, memory cards, and the like. Flash memory, as well as other types of non-volatile memory, can be electronically programmed/reprogrammed and erased.

Memory management operations, such as garbage collection and data consolidation (e.g., compaction), are typically performed in order to reclaim memory fragments from non-volatile memory systems that have old or stale data or to consolidate or organize memory fragments belonging to the same logical group of respective memory blocks. This may free up reclaimed memory fragments for reprogramming and may improve memory performance, such as random performance, due to the consolidation or organization of memory fragments. As non-volatile memory size in computing systems continue to grow, and such non-volatile memory systems are used by an increasing number and variety of hosts having different memory usage and patterns, operations, such as garbage collection and data consolidation, are relied upon to ensure data integrity and to improve memory performance. While operations, such as garbage collection and data consolidation, improve data integrity and memory performance, such operations can consume computing resources, which may have a negative impact on memory performance.

### SUMMARY

This disclosure relates generally to memory management systems and methods.

An aspect of the disclosed embodiments is a method for data consolidation in a memory system that includes selecting a source block for data consolidation from a plurality of memory blocks in the memory system. The method further includes reading a physical-to-logical address mapping table associated with the source block to determine a first logical group in the source block. The method further includes loading a first logical-to-physical address mapping table associated with the first logical group. The method further includes identifying, using the first logical-to-physical address mapping table, valid memory fragments of the source block that are associated with the first logical group. The method further includes consolidating the identified valid memory fragments associated with the first logical group.

Another aspect of the disclosed embodiments is a memory system that includes a non-volatile storage having an array of memory blocks storing data that is associated with logical block address (LBA) addresses; and a controller in communication with the memory blocks. The controller is configured to select a source block for data consolidation from the of memory blocks. The controller is further configured to read a physical-to-logical address mapping table associated with the source block to determine a first logical group in the source block. The controller is further configured to load a first logical-to-physical address mapping table associated with the first logical group. The controller is further configured to identify, using the first logical-to-physical address mapping table, valid memory fragments of the source block that are associated with the first logical group. The controller is further configured to consolidate the identified valid memory fragments associated with the first logical group.

Another aspect of the disclosed embodiments is a method for operating a memory system having a controller and blocks of memory. The method includes selecting a source block for data consolidation from blocks of memory. The method further includes reading a physical-to-logical address mapping table associated with the source block to determine a first logical group in the source block. The method further includes loading a first logical-to-physical address mapping table associated with the first logical group, wherein the first logical-to-physical address mapping table includes memory fragment entries that identify memory fragments of the first logical group and corresponding memory blocks for each memory fragment. The method further includes determining, using the first logical-to-physical address mapping table, valid memory fragments associated with the first logical group in the source block by identifying memory fragments corresponding to the source block. The method further includes consolidating the determined valid memory fragments associated with the first logical group.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B generally illustrates a block diagram of an example non-volatile memory system according to the principles of the present disclosure.

FIG. 2A generally illustrates a block diagram of example components of a controller according to the principles of the present disclosure.

FIG. 2B generally illustrates a block diagram of example components of a non-volatile memory storage system according to the principles of the present disclosure.

FIG. 3 generally illustrates a memory block according to the principles of the present disclosure.

FIGS. 4A-4B generally illustrate a memory block according to the principles of the present disclosure.

FIG. 5 is a flow diagram illustrating a reverse mapping and data consolidation method according to the principles of the present disclosure.

### DEFINITIONS

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Controller” shall mean individual circuit components, an application-specific integrated circuit (ASIC), a microcontroller with controlling software, a digital signal processor (DSP), a processor with controlling software, a field programmable gate array (FPGA), or combinations thereof.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described above, non-volatile memory systems provide a type of computer memory that retains stored information without requiring an external power source. One type of non-volatile memory, flash memory, is widely used in various computing devices and in stand-alone memory devices. For example, flash memory can be found in laptops, digital audio player, digital cameras, smart phones, video games, scientific instruments, industrial robots, medical electronics, solid state drives, USB drives, memory cards, and the like. Flash memory, as well as other types of non-volatile memory, can be electronically programmed/reprogrammed and erased.

Memory clean-up or management operations, such as garbage collection and data consolidation (e.g., compaction), may be routinely performed on the non-volatile memory systems in order to reclaim memory fragments that have old or stale data and/or to consolidate or organize memory fragments belonging to the same logical group in memory blocks of the memory systems. This may free up reclaimed memory fragments for reprogramming and may improve memory performance, such as random performance, due to the consolidation or organization of memory fragments. While operations, such as garbage collection and data consolidation, improve data integrity and memory performance, such operations can consume computing resources, which may have a negative impact on memory performance.

For example, random access pattern tests fill random memory blocks with data over a range of logical block addressing (LBA) addresses. As a result, logical flash management units (LFMU), which may be referred to as memory fragments, from the same logical group (e.g., a group of memory fragments logically grouped together) are scattered across a memory block. A memory block may include 16 memory fragments or other suitable number of memory fragments. A memory fragment may comprise a 4 kilobyte fragment of an associated memory block, or other suitable sized fragment.

When data is written to a memory fragment (e.g., a host write), an entry in a logical-to-physical address mapping table, which may be referred to as a group address table (GAT), is created. The entry, referred to as a memory fragment entry, indicates the memory fragment, and points to the memory block where the memory fragment is physically located. A physical-to-logical address mapping table, which may be referred to as a reverse GAT (RGAT), may represent information associated with a memory block. The information may indicate logical group numbers of logical groups having at least some memory fragments within the memory block. The information may further indicate offset values of the memory fragments within the memory block (e.g., the offset values may indicate a position or location of the memory fragment within the memory block). As a memory fragment is written to a memory block, the physical-to-logical mapping table associated with the memory block is updated to include the logical group number associated with the memory fragment. This may result in multiple redundant entries in the physical-to-logical mapping table as the memory block may include multiple memory fragments associated with the same logical group, with the physical-to-logical mapping table having a logical group number stored for each memory fragment.

As described above, memory management operations, data consolidation or compaction, may be performed on the memory blocks in order identify the memory fragments of a logical group (e.g., the memory fragments belonging to the same logical group that are scattered across one or more memory blocks) and to consolidate the memory fragments from the one or more memory blocks to a destination block. The result of such consolidation is typically, an unorganized set of valid memory fragments identified in the memory block. For example, valid memory fragments, as will be described, are consolidated in the destination block (e.g., only valid memory fragments are relocated to the destination block), but the valid memory fragments may not be sequentially ordered by logical group.

Typically, performing data consolidation in a memory system includes selecting a source block for consolidation. The source block may include any memory block of the memory system and may include memory fragments from various logical groups scattered across the source block. The memory fragments of the source block may include data written by a host or may be empty. Additionally, or alternatively, the memory fragments having data written by the host may be valid memory fragments (e.g., the location the memory system considers the source of the data written to the memory fragment) or invalid memory fragments (e.g., no longer the location the memory system considers the source of the data written to the memory fragment because the data has been rewritten elsewhere). As will be described, when a memory fragment is invalidated, the corresponding physical-to-logical address mapping table is not invalidated (e.g., not updated) due to control write amplification. Thus, the logical-to-physical address mapping table is read to confirm validity of the memory fragments in the source block.

Data consolidation operations are performed on the source block sequentially, starting with the first memory fragment in the source block. Positions, or locations, of memory fragments in the source block may be identified using an offset for the memory block. Accordingly, the memory fragment is identified by reading the physical-to-logical address mapping table, which includes information, as described, that identifies the logical group and memory fragment offset values, which indicate the position of the memory fragments. As described, each memory fragment is associated with a corresponding memory fragment entry in a logical-to-physical address mapping table.

A memory fragment entry in a first logical-to-physical address mapping table corresponding to the first memory fragment in the source block is read to determine whether the first memory fragment is valid with respect to the source block. The first memory fragment is determined to be valid if the corresponding memory fragment entry in the first logical-to-physical address mapping table points to the source block for the first memory fragment. Conversely, the first memory fragment is determined to be invalid if the memory fragment in the first logical-to-physical address mapping table does not point to the source block for the first memory fragment. If the first memory fragment is determined to be valid in the source block, the first memory fragment is relocated to a destination block. If the first memory fragment is determined to be invalid, the first memory fragment is ignored.

The physical-to-logical address mapping table is then read to identify a second memory fragment in the source block and to determine a logical group associated with the second memory fragment. The logical group associated with the second memory fragment may be the same or different than the logical group associated with the first memory fragment. If the logical group associated with the second memory fragment is the same as the logical group associated with the first memory fragment, the first logical-to-physical address mapping table is read, as described, to determine whether the second memory fragment is valid. Conversely, if the logical group associated with the second memory fragment is different from the logical group associated with the first memory fragment, a second logical-to-physical address mapping group is loaded in to cache and read, as described, to determine whether the second memory fragment is valid. Based on the validity of the second memory fragment, the second memory fragment is relocated to the destination block. As the memory fragments of the source block are validated and relocated, the same logical-to-physical address mapping table may be reloaded into cache and read multiple times. This may be inefficient and result in a decrease in overall memory system performance. Further, this may lead to a destination block that is consolidated (e.g., having only valid memory fragments) and unorganized (e.g., having valid memory fragments not grouped by logical groups). Accordingly, systems and methods, such as those disclosed herein, that provide a more efficient approach to memory fragment validation and consolidation, may be desirable.

Thus, at least some of the example embodiments are directed to consolidating memory fragments of the same logical group that are scattered across a memory block. The physical-to-logical address mapping table for a selected source block is used to identify the logical groups in the source block. The logical-to-physical address mapping tables associated with the identified logical groups are loaded in to cache. The number of logical-to-physical address mapping tables loaded to cache at once may depend on the availability and/or size of cache associated with the memory system. The first logical-to-physical address mapping table, associated with the first logical group, is read to identify memory fragments belonging to the first logical group.

For example, each memory fragment in the source block is read in sequential order and compared to the memory fragment entries in the first logical-to-physical address mapping table. Validity for each memory fragment having a memory fragment entry in the first logical-to-physical address mapping table is determined, as described above. Valid memory fragments identified in the source block belonging to the first logical group (e.g., using the first logical-to-physical address mapping table) are consolidated in sequential order in the destination block. Another logical-to-physical address mapping table, such as the second logical-to-physical address mapping table, described above, is read to identify memory fragments in the source block belonging to the second logical group.

As described, valid memory fragments belonging to the second logical group are sequentially consolidated in the destination block. The remaining logical-to-physical address mapping tables associated with logical groups identified as having memory fragments in the source block are sequentially read and all identified valid memory fragments for all logical groups in the source block are sequentially consolidated to the destination block. Accordingly, a logical-to-physical address mapping table associated with a logical group is only loaded into cache once and all memory fragments associated with the logical group are identified, validated, and relocated to the destination block and grouped by logical group (e.g., because all valid memory fragments belonging to a logical group are identified while the logical-to-physical mapping table corresponding to a logical group is read, resulting in identification and relocation of memory fragments belonging to the same logical group before identifying and relocating memory fragments belonging to a different logical group). This may improve efficiency and reduce the resources required to perform data consolidation operations on memory blocks in the memory system. Additionally, or alternatively, the memory fragment offset values in the physical-to-logical address mapping table may be unnecessary as it is not used to identify the memory blocks. Accordingly, the memory fragment offset value is not written to the physical-to-logical address mapping table, which may improve efficiency and reduce the resources required to address the memory fragments and/or to perform data consolidation operations (e.g., because the write amplification of the physical-to-logical address mapping table increases when an entry for each memory fragment offset value is added to the physical-to-logical address mapping table). Additionally, or alternatively, as a memory fragment is written to a memory block (e.g., such as the source memory block or other suitable memory block) a logical group number associated with the memory fragment is compared to logical group numbers already stored in the physical-to-logical mapping table associated with the memory block. If the logical group number associated with the memory fragment is already stored in the physical-to-logical mapping table, no changes are made to the physical-to-logical mapping table. Conversely, if the logical group number associated with the memory fragment is not found in the physical-to-logical mapping table, the logical group number is added to the physical-to-logical mapping table. This may reduce or eliminate redundant information stored in the physical-to-logical mapping table (e.g., by only including the logical group number once for each logical group represented in the memory block). The specification now turns to an example computer architecture that utilizes memory, in accordance with example embodiments.

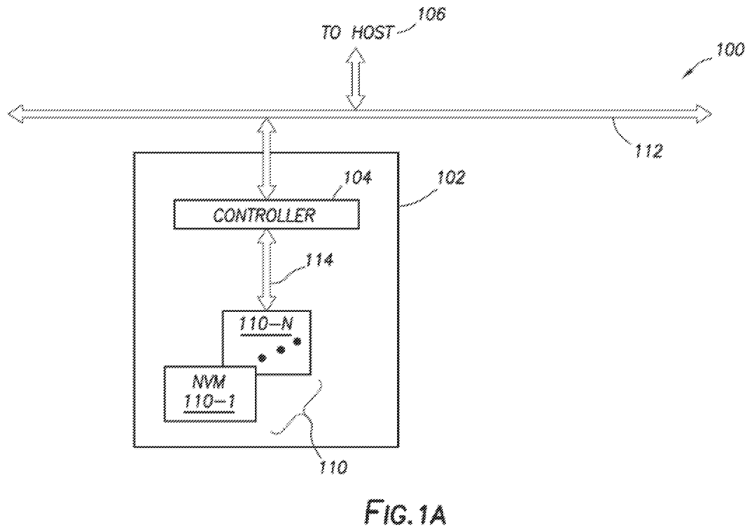

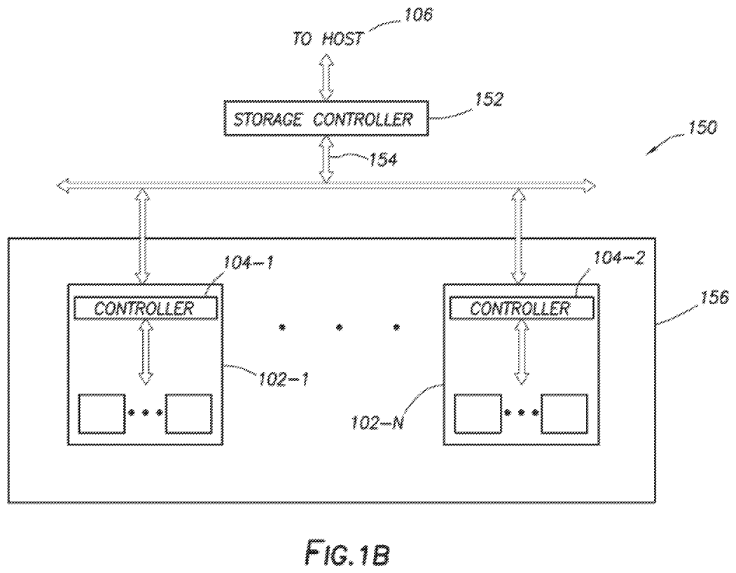

FIG. 1A illustrates a block diagram of an example system architecture 100 including non-volatile memory. In particular, the example system architecture 100 includes storage system 102 (e.g., which may be referred to as a memory system), a controller 104, and a host 106. In various embodiments, the host 106 can include any device or system that utilizes the storage system 102. The host 106 can include its own controller (e.g., a processor) configured to execute instructions stored in the storage system 102 and further the host 106 can access data stored in the storage system 102.

Examples of the host 106 include computing devices such as a desktop computer, rack mounted server, a laptop, a smartphone, a tablet, or other suitable computing devices. Host 106 can also include systems and devices such as a gaming system, a digital phone, a digital camera (e.g., digital still cameras and digital movie cameras), portable media player, digital photo frame, remote control, television stick, smart television, and the like. Furthermore, the system architecture 100 can be implemented in a memory card such as secure digital (SD) card or a micro secure digital (micro-SD) card. In some embodiments, the system architecture 100 is embedded in the host, for example as a solid state disk (SSD) drive installed in a laptop computer.

In embodiments where the system architecture 100 is implemented within a memory card, the host 106 can include a built-in receptacle for one or more types of memory cards or flash drives (e.g., a universal serial bus (USB) port, or a memory card slot). Additionally, or alternatively, the host 106 can include adapters into which a memory card may be plugged. The foregoing examples of a host are not meant to be limiting examples. On the contrary, a host 106 can include any type of device, system, and apparatus that accesses the storage system 102.

In FIG. 1A, the storage system 102 includes a memory controller and drivers (e.g., controller 104)—as will be described further below—however, in some embodiments of the storage system 102, the storage system 102 may include memory-only units that are instead controlled by software executed by a controller on the host 106 (e.g., a processor of a computing device controls, including error handling of, the storage system 102). Furthermore, although FIG. 1A illustrates the storage system 102 as separate from the host 106, in some embodiments, the storage system 102 is embedded with the host 106, where the memory, controller, and drivers are formed on a single integrated circuit chip.

The host 106 can communicate with the storage system 102 using of a bus 112 that implements any known or after developed communication protocol that enables the storage system 102 and the host 106 to communicate. The communication protocol may include Secure Digital (SD) protocol, Memory stick (MS) protocol, USB protocol, Advanced Microcontroller Bus Architecture (AMBA), or other suitable communication protocol.

In various embodiments, the controller 104 acts as an interface between the host 106 and the storage system 102. The controller 104 can include individual circuit components, processing circuitry (e.g., logic gates and switches), a processor, a microprocessor, a microcontroller with controlling software, or a field programmable gate array (FPGA). Furthermore, the example controller 104 includes a computer-readable medium that stores computer-readable program code (e.g., software or firmware) executable by the processor. In some embodiments, the controller 104 is a flash memory controller. In some embodiments, the controller 104 is a processor executing within the host 106.

Still referring to FIG. 1A, according to some embodiments, the controller 104 acts as an interface between the host 106 and the storage system 102 and manages data stored on the storage system 102. For example, the host 106 can access data stored in the storage system 102 by providing a logical address to the controller 104, which, the controller 104 converts to a physical address. The controller 104 can access data and/or a particular storage location associated with the physical address and facilitate transferring data between the storage system 102 and the host 106. In some embodiments, where the storage system 102 includes flash memory, the controller 104 formats the flash memory to ensure the memory is operating properly, maps out bad flash memory cells, and allocates spare cells to be substituted for future failed cells or used to hold firmware to operate the flash memory controller (e.g., the controller 104).

Accordingly, the controller 104 performs various memory management functions such as wear leveling (e.g., distributing writes to extend the lifetime of the memory blocks), garbage collection (e.g., moving valid pages of data to a new block and erasing the previously used block), and error detection and correction (e.g., read error handling).

Still referring to FIG. 1A, the storage system 102 includes the non-volatile memory (NVM) block 110 which may include several memory die 110-1-110-N. In some embodiments, the NVM block 110 defines a physical set of memory die, such as the memory die 110-1-110-N. In other embodiments, the NVM block 110 defines a logical set of memory die, where the NVM block 110 includes memory die from several physically different sets of memory die. The manner in which the NVM block 110 is defined in FIG. 1A is not meant to be limiting.

Each memory die, for example memory die 110-1, includes non-volatile memory cells, such as NAND flash memory cells or NOR flash memory cells. As the memory cells are non-volatile, the memory cells in the storage system 102 retain data even when there is an interruption in power supplied to the memory cells and/or the storage system 102. Thus, the storage system 102 can be easily transported and the storage system 102 can be used in memory cards and other memory devices that are not always connected to a power supply.

In various embodiments, the memory cells in the memory die 110 are solid-state memory cells (e.g., flash) and are one-time programmable, few-time programmable, or many time programmable. Additionally, the memory cells in the memory die 110 can include single-level cells (SLC), multiple-level cells (MLC), or triple-level cells (TLC). In some embodiments, the memory cells are fabricated in a planar manner (e.g., 2D NAND (NOT-AND) flash) or in a stacked or layered manner (e.g., 3D NAND flash). That is, planar flash memory includes a single layer of memory cell, while stacked flash memory includes memory cells that are stacked vertically in multiple layers.

In some embodiments, and as shown in FIG. 1A, the controller 104 and the NVM block 110 are communicatively coupled by an interface 114 that implements any known or after developed communication protocol. In embodiments where the storage system 102 is flash memory, the interface 114 is a flash interface, such as Toggle Mode 200, 400, or 800, or Common Flash Memory Interface (CFI). In various embodiments, the interface 114 can be implemented by several channels (i.e., physical connections) disposed between the controller 104 and the individual memory die 110-1-110-N. Furthermore, the number of channels over which the interface 114 is established varies based on the capabilities of the controller 104. Additionally, a single channel can be configured to communicatively couple more than one memory die. The depiction of a single interface 114 is not meant to be limiting. To the contrary, the single interface is representative of an example interface that can be used between components, and one or more interfaces can be used to communicatively couple the same components.

FIG. 1B generally illustrates a block diagram of a system architecture according 100 to the principles of the present disclosure. The system architecture 100 can be implemented as part of a larger system architecture. For example, as shown in FIG. 1B, the system architecture 150 includes a storage module 156 that further includes several storage systems 102. Within the example system architecture 150 the storage module 156 is communicatively coupled with the host 106 by way of a storage controller 152. In particular, an interface 154 between the host 106 and the storage module 156 includes a bus interface that implements any known or after developed communication protocol, such as a serial advanced technology attachment (SATA) or peripheral component interface express (PCIe) interface. In some embodiments, the storage module 156 is an SSD (e.g., in a laptop computer or a tablet).

Some implementations of the system architecture 100 include a hierarchical storage system. A hierarchical storage system can include a plurality of storage controllers 152, each of which control a respective storage system 102. Furthermore, a plurality of hosts 106 can each access the hierarchical storage system. Hosts 106 can access memories within the hierarchical storage system via a bus interface that implements any known or after developed communication protocol including a non-volatile memory express (NVMe) or a fiber channel over Ethernet (FCoE) interface. The hierarchical storage system can be implemented as a rack mounted storage system that is accessible by multiple host computers (e.g., a data center).

The interface 154 can be implemented by several channels (i.e., physical connections) disposed between the storage controller 152 and the storage module 156. In some embodiments, the number of channels over which an interface 154 is established varies based on the capabilities of the storage controller 152. The depiction of a single interface is not meant to be limiting and the single interface is representative of an example interface that can be used between components, where one or more interfaces can be used to communicatively couple various components.

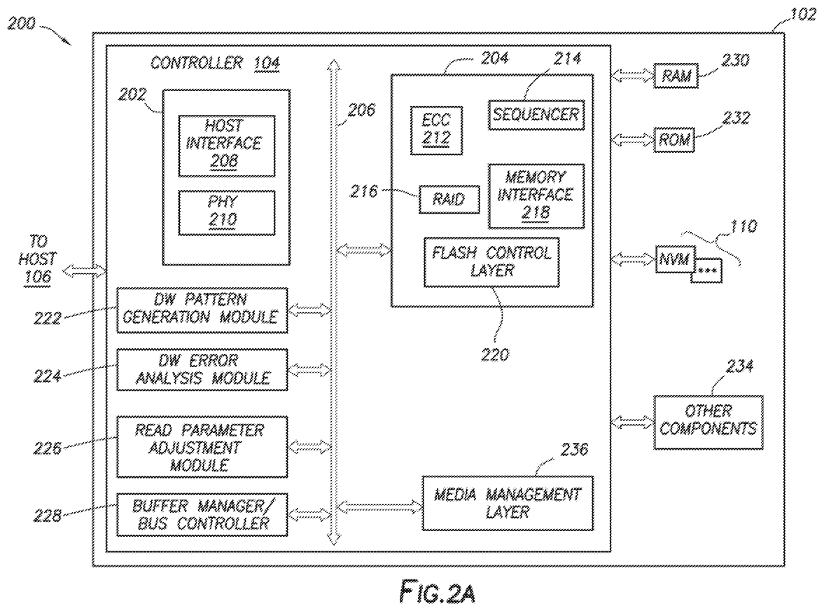

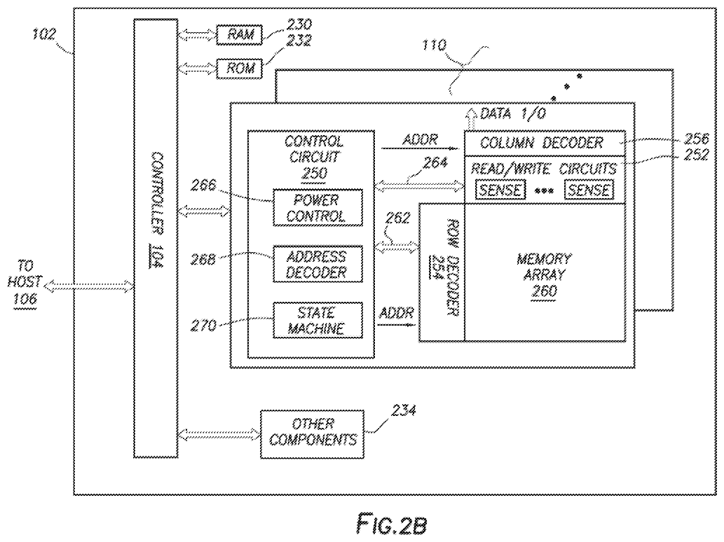

FIG. 2A generally illustrates a block diagram 200 of the storage system 102, according to the principles of the present disclosure. The block diagram 200 of the storage system 102 includes components previously described in FIG. 1A, such as the controller 104 and the NVM memory block 110. Additional components that can be present within the storage system 102 include a random access memory (RAM) 230, a read only memory (ROM) 232, and other components 234. In some embodiments, the ROM 232 stores system boot code.

Although the RAM 230 and the ROM 232 are shown as separate modules within the storage system 102, the illustrated architecture is not meant to be limiting. For example, the RAM 230 and the ROM 232 can be located within the controller 104. In some embodiments, portions of the RAM 230 or ROM 232, respectively, are located outside the controller 104 and within the controller 104. In other embodiments, the controller 104, the RAM 230, and the ROM 232 can be located on separate semiconductor die. In various embodiments, the other components 234 include external electrical interfaces, external RAM, resistors, capacitors, logic gates, or other components that interface with the controller 104.

In some embodiments, the controller 104 includes a module 202 that interfaces with the host 106, a module 204 that interfaces with the NVM memory block 110, as well as various other modules, described further below. The modules within the controller (e.g., modules 202 and 204) are communicatively coupled to each other by a bus 206.

The following discussion of the various modules depicted within the controller 104 are meant to be illustrative and not limiting. For example, the various modules generally illustrated in FIG. 2A are not limited to being executed within the controller 104, and in some embodiments, one or more modules can be executed outside the controller 104.

The module 202 interfaces with the host 106 and includes a host interface 208 and a physical layer interface 210 that provides the electrical interface between the host 106 or next level storage controller and the controller 104. The host interface 208 facilitates transferring of data, control signals, and timing signals. Examples of the host interface 208 include SATA, SATA express, Serial Attached SCSI (SAS), Fibre Channel, USB, PCIe, and NVMe.

Still referring to FIG. 2A, in various embodiments, the module 204 is configured to communicate with the NVM block 110 and includes an error correcting code (ECC) engine 212. In some embodiments, the ECC engine 212 encodes data received from the host 106 and stores the encoded data in the NVM block 110. When the data is read out from the NVM memory block 110, the ECC engine 212 decodes the data and corrects errors detected within the data To detect errors, the ECC engine 212 implements various types of error checking using algorithms such as low-density parity-check (LDPC) code, Bose-Chaudhuri-Hocquenghem (BCH) code, a soft read, and/or extra parity.

The example module 204 also includes a sequencer 214 and a Redundant Array of Independent Drives (RAID) module 216. In various embodiments, the sequencer 214 generates command sequences, such as program and erase command sequences that are transmitted to the NVM memory block 110. The RAID module 216 generates RAID parity and recovery of failed data. The RAID parity can be used to provide an additional level of integrity protection for data written into the NVM memory block 110. In some embodiments, the ECC engine 212 implements the functions of the RAID module 216.

The example module 204 also includes a memory interface 218 that provides the command sequences to the NVM memory block 110 and receives status information from the NVM memory block 110. For example, the memory interface 218 implements any known or after developed communication protocol including a double data rate (DDR) interface, such as a Toggle Mode 200, 400, or 800 interface. The module 204 also includes a flash control layer 220 that controls the overall operation of the module 204.

Still referring to example modules within the controller 104 in FIG. 2A, additional modules within the controller 104 includes a dummy word line (DW) pattern generation module 222, a DW error analysis module 224, and a read parameter adjustment module 226. Dummy word lines are placed on non-volatile memory die that are used for the purposes of analyzing and tracking behavior and health of a respective non-volatile memory die. In various embodiments, the DW pattern generation module 222 puts a known data pattern into a dummy word line and tracks or periodically check for errors by reading the data back out of the dummy word line and comparing the data to the known data pattern.

In various embodiments, the read parameter adjustment module 226 adjusts parameters associated with a particular non-volatile memory die. For example—and as discussed further below—the read parameters adjustment module 226 can adjust parameters associated with a particular non-volatile memory die during an operation—i.e., a read or write—to adjust or re-adjust the read parameters. During the operation to re-adjust the read parameters, the read parameter adjustment module 226 adjusts the read parameters for a particular memory block, reads data out of the memory block, and verifies a resulting BER. If the resulting BER falls at or below a target or expected BER, the read parameters adjustment module 226 stores the read parameters for the memory block. Subsequently, the stored read parameters are used during a read of any word line within the memory block. Thus read parameters can be unique to a memory block.

Additional modules within the example controller 104 include a buffer manager/bus controller 228 that manages, for example, buffers in the RAM 230 and controls the internal bus arbitration of the bus 206 in the controller 104. Additionally, or alternatively, the controller 104 can include a media management layer 236 that performs wear leveling of the NVM memory block 110. As previously mentioned, the various modules described with respect to the controller 104 are not meant to be limiting as to the architecture of the controller 104. For example, the physical layer interface 210, the RAID module 216, the media management layer 236, and the buffer management/bus controller 228 can be examples of optional components within the controller 104.

Furthermore, in embodiments where the storage system 102 includes flash memory, the media management layer 236 can be integrated as part of the flash management that handles flash error and interfaces with the host 106. In particular, the media management layer 236 can include an algorithm (e.g., firmware in the memory device), that translates a write command received from the host 106 into a write to the NVM memory block 110.

FIG. 2B generally illustrates a block diagram with various features of the NVM memory block 110 within the storage system 102. As details of the controller 104 have been previously described (in FIG. 2A), in FIG. 2B the controller 104 is illustrated as a single block. Additionally, previously described RAM 230, the ROM 232, and the other components 234 are included in FIG. 2B to help orient the reader. Next, details within an example memory die 110-1 are discussed. Although the discussion centers on the memory die 110-1, each of the features discussed in relation to the memory die 110-1 equally applies to all the memory die within NVM memory block 110.

In some embodiments, the example memory die 110-1 includes control circuit 250, read/write circuits 252, a row decoder 254, a column decoder 256, and a memory array 260. The memory array 260 can include a two-dimensional array or a three-dimensional array of memory cells. The read/write circuits 252 read and program pages of memory within the memory die 110-1, in parallel. In various embodiments, the memory array 260 is accessed by word lines via the row decoder 254 and by bit lines via the column decoder 256.

The architecture of the memory die 110-1 is not meant to be limiting and any known architecture that can perform the functions of accessing the memory array 260 can be used without departing from the scope of this disclosure. For example, in various embodiments, access to the memory array 260 by various peripheral circuits can be implemented in a symmetric fashion on opposite sides of the memory array 260 which reduces the densities of access lines and circuitry on each side of the memory array 260.

Still referring to FIG. 2B, in various embodiments, the example control circuit 250 includes a power control circuit 266, an address decoder 268, and a state machine 270. In some embodiments, the power control circuit 266, the address decoder 268, and the state machine 270 can be collectively referred to as managing circuits. The control circuit 250 and its various managing circuits, are communicatively coupled by various interfaces (e.g., interfaces 262 and 264) to the row decoder 254 and the column decoder 256. In various embodiments, the control circuit 250 performs various operations on the memory array 260 that include reading or writing to the memory cells.

The power control circuit 266 controls the power and voltage supplied to the word lines and bit lines during operation of the memory array 260. The address decoder 268 provides an address interface that translates addresses between addresses provided by the host 106 and addresses used by the row decoder 254 and the column decoder 256. The example address decoder 268 converts an address provided by the host 106 to an address that is understood and compatible with a format used by the row decoder 254 and the column decoder 256. The state machine 270 provides chip-level control of memory operations.

Thus, the storage system 102 includes various components including the controller 104 and the NVM memory block 110, details of which have been described above in FIGS. 1A, 1B, 2A, and 2B. The discussion now turns to an example architecture of an example memory array 260 and in particular methods that can be performed to improve a performance of a read in the storage system 102.

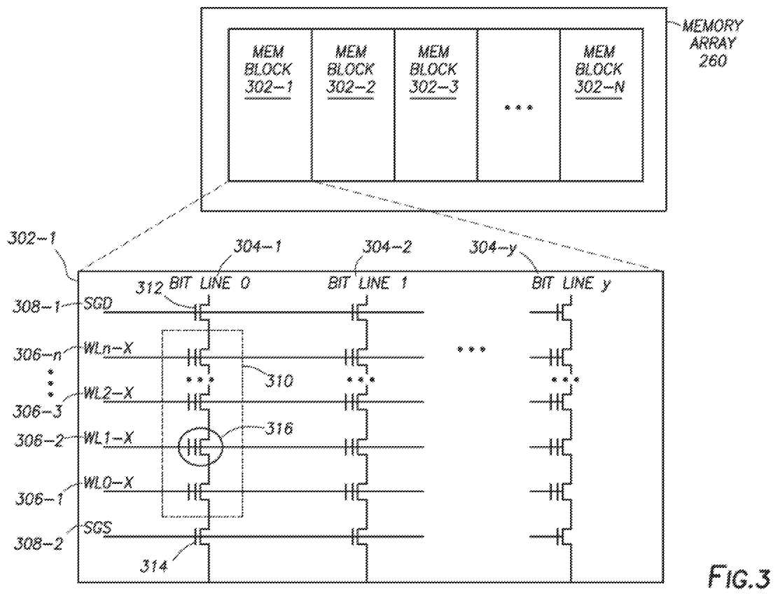

FIG. 3 further illustrates the memory array 260. The memory array 260 is divided into several memory blocks 302. In flash memory, a memory block is defined as a unit of erase. That is, each memory block 302 includes a number of memory cells that are erased together or as a block. In some embodiments, the memory array 260 can be partitioned into any number of blocks, for example, the memory array 260 includes 1,024 blocks. Additionally, or alternatively, each of the memory blocks 302 can conceptually be divided into a number of pages defined as a unit of programming. In some embodiments, a page of data can be stored in one row of memory cells. Each page can include user data and overhead data, where the overhead data includes CC that has been calculated from the user data.

Each memory block 302, for example memory block 302-1, includes multiple bit lines 304, word lines 306, and select lines 308. Each bit line, for example bit line 304-1, is connected to several memory cells connected in series. More particularly, in an embodiment where each memory cell is a floating gate transistor, the floating gate transistors are connected in series to form a NAND string 310 (e.g., illustrated within the dashed box). Although four memory cells are shown in FIG. 3, the number of memory cells within the NAND string is not meant to be limiting. For example, 16, 32, 64, 128, or any other number of memory cells can be connected in a NAND string. Each respective bit line 304 is coupled to a respective NAND string within the block 302.

Still referring to FIG. 3, a method of reading data stored in a particular memory cell—e.g., memory cell 316—includes applying a voltage to the select lines 308 of the block 302, which in turn are coupled to respective NAND strings within the block 302, including the NAND string 310 the includes the memory cell 316. The voltage applied to the select lines 308 is greater than threshold voltages of the select transistors 312 and 314. The select transistor 312 is controlled by the select gate drain line (SGD) 308-1 and the select transistor 314 is controlled by the select gate source line (SGS) 308-2. Additionally, in order to read data in the memory cell 316, all other memory cells or unselected memory cells in the NAND string 319 are turned on (e.g., conducting current regardless of whether they are programmed or erased). The unselected memory cells have a read pass voltage—i.e., read parameters—applied to their respective word lines that turn on the unselected memory cells.

During the example read operation, various read compare levels—i.e., voltages—are applied to the word line 306-2 to determine the value stored in the memory cell 316. In some embodiments, the conduction current of the memory cell 316 is measured to determine the value stored within the memory cell 316. The method in which each memory cell is accessed and the number of memory cells accessed during a read or write varies. For example, all of the bit lines of the memory block 302-1 can be simultaneously programmed or read. In various embodiments, memory cells along a shared word line can be programmed at the same time (i.e., concurrently). In other embodiments, the bit lines can be divided into even bit lines and odd bit lines. In an odd/even bit line architecture, memory cells along a shared word line and connected to the odd bit lines are programmed at one time, while memory cells along a shared word line and connected to an even bit line are programmed at a different time.

Each time data is written to a memory block the data is processed by the ECC engine 212 which includes encoding the data (e.g., using a particular error correction code) and storing the encoded data in the memory block. When the data is read back out of the memory block, the data is processed by the ECC engine 212 which includes decoding the data, correcting errors (e.g., tracked as the BER), and returning the data to a user (by way of the controller 104). In some embodiments, the amount of time the ECC engine 212 takes to return data to the controller 104 is defined as the throughput time.

In some embodiments, the controller 104 performs data consolidation operations on the memory array 260. The controller 104 selects a source block from the memory block 302-1 to memory block 302-N of the memory array 260, for consolidation or compaction. For example, the controller 104 may select memory block 302-1 as the source block for consolidation or compaction. The memory block 302-1 may be referred to as the source block 302-1 throughout the example embodiments described herein. The source block 302-1 may include a plurality of memory fragments, such as 16 memory fragments or any suitable number of memory fragments. The memory fragments may include data written by the host 106 during a host write operation. The memory fragments may belong to respective logical groups and may be scattered or disorganized in the source block 302-1, such that memory fragments associated with the same logical group may not be sequentially stored or organized in the source block 302-1. Additionally, or alternatively, while some memory fragments include data written by the host 106 during a host write operation, other memory fragments scattered throughout the source block 302-1 may be blank (e.g., having been erased by the host 106 or the controller 104 or having not been written to by the host 106).

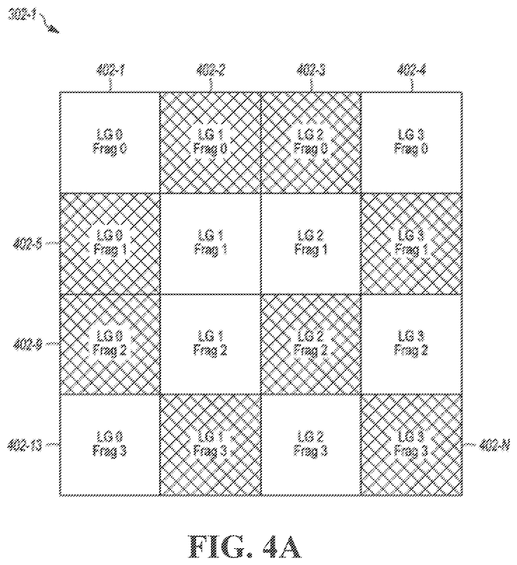

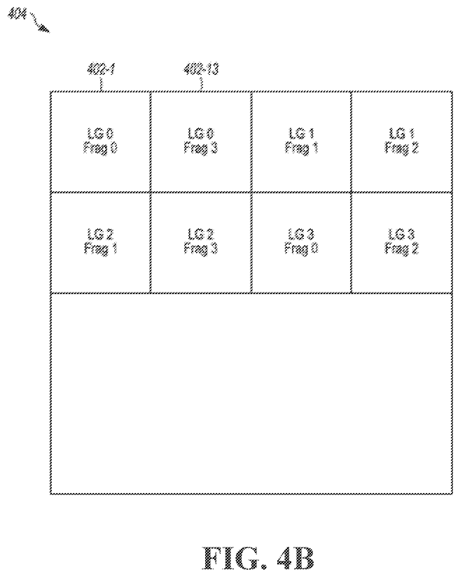

FIG. 4A generally illustrates a memory block, such as the source block 302-1, having a random data distribution. The source block 302-1 includes a plurality of memory fragments 402-1 to 402-N, where, for example, N equals 16 or any suitable number corresponding to the total number of memory fragments in the source block 302-1. The memory fragments 402-1 to 402-N are written with the random data by, for example, the host 106. It should be understood that while only the source block 302-1 is illustrated and described herein, any suitable memory block 302-1 to 302-N of the memory array 260 includes similar features and may be selected as the source block. In the example illustrated in FIG. 4A, each of the memory fragments 402-1 to 402-N includes an LG (e.g., logical group) number corresponding to the logical group the memory fragment belongs to and a Frag (e.g., memory fragment) number corresponding to a memory fragment number of the logical group. For example, memory fragment 402-1 belongs to logical group 0 and is memory fragment 0 of logical group 0. As is illustrated, four logical groups (0, 1, 2, and 3) have memory fragments in the source block 302-1. Further, memory fragments having hashing illustrated in FIGS. 4A and 4B represent invalid memory fragments while memory fragments without hashing represent valid memory fragments.

A described, the controller 104 reads a physical-to-logical address mapping table associated with the selected source block 302-1. The controller 104 identifies the logical groups in the source block 302-1 using the physical-to-logical address mapping table. The physical-to-logical address mapping table includes logical group entries that indicate logical group numbers corresponding to logical groups in the source block 302-1. As described, as a memory fragment is written to a memory block (e.g., such as the source memory block 302-1 or other suitable memory block) a logical group number associated with the memory fragment is compared to logical group numbers already stored in the physical-to-logical mapping table associated with the memory block. If the logical group number associated with the memory fragment is already stored in the physical-to-logical mapping table, no changes are made to the physical-to-logical mapping table. Conversely, if the logical group number associated with the memory fragment is not found in the physical-to-logical mapping table, the logical group number is added to the physical-to-logical mapping table. This may reduce or eliminate redundant information stored in the physical-to-logical mapping table (e.g., by only including the logical group number once for each logical group represented in the memory block).

As described, each of the logical groups 0-3 have an associated logical-to-physical address mapping table. For example, logical group 0 may correspond to a first logical-to-physical address mapping table, logical group 1 may correspond to a second logical-to-physical address mapping table, and so on. The controller 104 may load the logical-to-physical address mapping tables associated with the identified logical groups (e.g., logical groups 0-3) in the source block 302-1 to cache. As described, the number of logical-to-physical address mapping tables that are loaded to cache varies depending on the availability and/or size of the cache associated with the storage system 102.

The controller 104 reads the first logical-to-physical address mapping table, which is associated with logical group 0. The controller 104 identifies memory fragments in the source block 302-1 associated with the logical group 0. For example, the controller 104 may identify memory fragments 402-1, 402-5, 402-9, and 402-13 as belonging to logical group 0.

The controller 104 determines whether each of the memory fragments 402-1, 402-5, 402-9, and 402-13 are valid memory fragments for the source block 302-1. For example, the controller 104 reads the first logical-to-physical address mapping table to determine whether a memory fragment entry corresponding to the memory fragment 402-1 points to the source block 302-1. If the controller 104 determines that the memory fragment entry in the first logical-to-physical address mapping table corresponding to the memory fragment 402-1 points to the source block 302-1, the controller 104 determines that the memory fragment 402-1 is valid. For purposes of this example, the memory fragment entry in the first logical-to-physical address mapping table corresponding to the memory fragment 402-1 points to the source block 302-1. Accordingly, the controller 104 determines that the memory fragment 402-1 is valid. The controller 104 then determines whether the memory fragment 402-5 is valid. For purposes of this example, the memory fragment entry in the first logical-to-physical address mapping table corresponding to the memory fragment 402-5 does not point to the source block 302-1. Accordingly, the controller 104 determines that the memory fragment 402-5 is invalid. The controller 104 continues to determine whether the memory fragment 402-9 and 402-13 are valid. For purposes of this example, the controller 104 determines that memory fragment 402-9 is invalid and memory fragment 402-13 is valid.

In some embodiments, the controller 104 may then consolidate the valid memory fragments 402-1 and 402-13 by relocating (e.g., copying the data in the memory fragments 402-1 and 402-13) to a destination block 404, as is generally illustrated in FIG. 4B. The destination block 404 may be one of the memory blocks 302-2 to 302-N (e.g., not memory block 302-1 as memory block 302-1 is selected as the source block) of the memory array 260 or the destination block 404 may be any other suitable memory block in the storage system 102. As is illustrated, memory fragments 402-1 and 402-13 are sequentially consolidated in the destination block 404, such that, all valid memory fragments associated with logical group 0 (e.g., memory fragments 402-1 and 402-13) identified in the source block 302-1 are grouped together in the destination block 404. In this manner, the first logical-to-physical address mapping table (e.g., and all other logical-to-physical mapping tables) is only loaded into cache once to identify all valid memory fragments 402-1 to 402-N in the source block 302-1 associated with the logical group 0.

In some embodiments, after the controller 104 has identified all valid memory fragments associated with logical group 0 and consolidated the identified valid memory blocks to the destination block 404, the controller 104 may then use the physical-to-logical address mapping table, to identify a subsequent logical group and continue as described above until the controller 104 has identified all logical groups in the source block 302-1 and consolidated all valid memory fragments associated with the various logical groups in the source block 302-1. That is, the controller 104 may read the first logical-to-physical address mapping table to identify and consolidate the valid memory fragments in the source block 302-1 associated with logical group 0 and then may read the physical-to-logical address mapping table to identify a second logical group in the source block 302-1. The controller 104 may load a second logical-to-physical address mapping table to cache and read the second logical-to-physical address mapping table to identify and consolidate valid memory fragments in the source block 302-1 associated with the logical group 1.

In some embodiments, the controller 104 may load multiple logical-to-physical address mapping tables to cache and continue as described above without rereading the physical-to-logical address mapping table after consolidating identified valid memory fragments associated with corresponding logical groups. That is, the controller 104 may read the first logical-to-physical address mapping table to identify and consolidate the valid memory fragments associated with logical group 0, as described, and then read a second logical-to-physical address mapping table already loaded in cache to identify and consolidate valid memory fragments with logical group 1.

The controller 104 continues to identify valid memory fragments 402-1 to 402-N using respective logical-to-physical address mapping tables for each logical group 0-3 identified in the source block 302-1. The controller 104 consolidates valid memory fragments 402-1 to 402-N associated with each of the identified logical groups 0-3 until all of the memory fragments 402-1 to 402-N have been determined to be valid and consolidated to the destination block 404 or determined to be invalid and ignored.

As is generally illustrated in FIG. 4B, the controller 104 relocates the valid memory fragments 402-1 to 402-N for each of the logical groups 0-3 in sequential order in the destination block 404. As a result, the logical groups 0-3 may be easier to search and invalid memory fragments may be reclaimed for reprogramming or rewriting. Additionally, or alternatively, by only loading each logical-to-physical address mapping table to cache ones, efficiency of the data consolidation operation may be improved and resources required to perform the data consolidation operation may be reduced. In some embodiments, after all of the valid memory fragments 402-1 to 402-N have been relocated to the destination block 404, the source block 302-1 may be erased and conditioned for reprogramming by the controller 104 (or by the host 106), such that the host 106 may reprogram or rewrite to the source block 302-1.

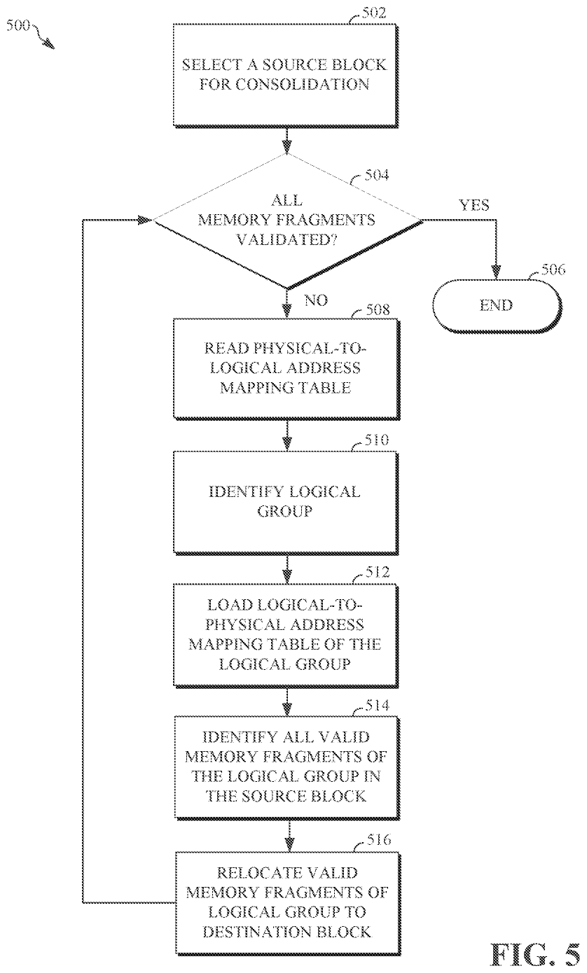

FIG. 5 generally illustrates flow diagram illustrating a reverse mapping and data consolidation method 500 according to the principles of the present disclosure. In some embodiments, the controller 104 may perform the methods described herein. However, the methods described herein as performed by the controller 104 are not meant to be limiting, and any type of software executed on a controller can perform the methods described herein without departing from the scope of this disclosure. For example, a controller such as a processor executing software within the host 106 or firmware within the storage system 102 (e.g., stored on ROM 232 or NVM memory block 110) can perform the methods described herein.

At 502, the method 500 selects a source block for consolidation. For example, as described, the controller 104 may select a memory block 302-1 to 302-N from the memory array 260 as the source block for data consolidation. At 504, the method 500 determines whether all memory fragments in the source block have been validated. For example, as described, the controller 104 determines the validity of each memory fragment 402-1 to 402-N in the source block 302-1. If the controller 104 has not determined the validity of all of the memory fragments 402-1 to 402-N in the source block 302-1, the method 500 continues at 508. If the controller 104 has determined the validity of all of the memory fragments 402-1 to 402-N in the source block 302-1, the method ends at 506.

At 508, the method 500 reads a physical-to-logical address mapping table associated with the source block. As described, as a memory fragment is written to a memory block (e.g., such as the source memory block 302-1 or other suitable memory block) a logical group number associated with the memory fragment is compared to logical group numbers already stored in the physical-to-logical mapping table associated with the memory block. If the logical group number associated with the memory fragment is already stored in the physical-to-logical mapping table, no changes are made to the physical-to-logical mapping table. Conversely, if the logical group number associated with the memory fragment is not found in the physical-to-logical mapping table, the logical group number is added to the physical-to-logical mapping table. This may reduce or eliminate redundant information stored in the physical-to-logical mapping table (e.g., by only including the logical group number once for each logical group represented in the memory block). The controller 104 may identify a physical-to-logical address mapping table associated with the source block 302-1. The controller 104 reads the physical-to-logical address mapping table associated with the source block 302-1. At 510, the method 500 identifies a logical group of the source block. As described, the controller 104 reads the physical-to-logical address mapping table associated with the source block 302-1 to identify a first logical group, such as logical group 0, of the source block 302-1. At 512, the method 500 loads a logical-to-physical address mapping table corresponding to the identified logical group to cache. As described, the controller 104 may load the first logical-to-physical address mapping table associated with logical group 0 to cache.

At 514, the method 500 identifies all memory fragments associated with the logical group in the source block. As described, the controller 104 identifies all memory fragments 402-1 to 402-N of the source block 302-1 that are associated with logical group 0. The controller 104 also determines whether each of the identified memory fragments 402-1 to 402-N of logical group 0 are valid. For example, the controller 104 reads the first logical-to-physical address mapping table and identifies memory fragment entries corresponding to respective ones of the memory fragments 402-1 to 402-N (e.g., of logic group 0) and determines whether the memory fragment entries for each respective memory fragments 402-1 to 402-N of logical group 0 point to the source block 302-1. The controller 104 determines that a memory fragment is valid if the corresponding memory fragment entry in the first logical-to-physical address mapping table points to the source block 302-1. Conversely, the controller 104 determines that a memory fragment is invalid if the corresponding memory fragment entry in the first logical-to-physical address mapping table does not point to the source block 302-1. At 516, the method relocates the identified valid memory fragments of the logical group to a destination block. As described, the controller 104 may sequentially relocate the valid memory fragments 402-1 to 402-N of logical group 0 to the destination block 404. The method 500 continues at 504 and continues to traverse the source block until all memory fragments have been identified, validated, and consolidated (e.g., relocated to the destination block).

In some embodiments, a method for data consolidation in a memory system includes selecting a source block for data consolidation from a plurality of memory blocks in the memory system. The method further includes reading a physical-to-logical address mapping table associated with the source block to determine a first logical group in the source block. The method further includes loading a first logical-to-physical address mapping table associated with the first logical group. The method further includes identifying, using the first logical-to-physical address mapping table, valid memory fragments of the source block that are associated with the first logical group. The method further includes consolidating the identified valid memory fragments associated with the first logical group.

In some embodiments, the first logical-to-physical address mapping table includes a plurality of memory fragment entries that indicate memory fragment associated with the first logical group and corresponding memory blocks for each memory fragment. In some embodiments, the first logical-to-physical address mapping table includes 1024 memory fragment entries. In some embodiments, identifying, using the first logical-to-physical address mapping table, valid memory fragments of the source block that are associated with the first logical group includes identifying memory fragments entries that indicate memory fragments corresponding to the source block. In some embodiments, the memory fragments include 4 kilobyte memory fragments. In some embodiments, consolidating the identified valid memory fragments includes grouping the identified valid memory fragments for the first logical group sequentially in a destination block. In some embodiments, the method further includes reading the physical-to-logical address mapping table associated with the source block to determine a second logical group in the source block and loading a second logical-to-physical address mapping table associated with the second logical group. In some embodiments, the method further includes identifying, using the second logical-to-physical address mapping table, valid memory fragments of the source block that are associated with the second logical group and consolidating the identified valid memory fragments associated with the second logical group.

In some embodiments, a memory system includes a non-volatile storage having an array of memory blocks storing data that is associated with logical block address (LBA) addresses; and a controller in communication with the memory blocks. The controller is configured to select a source block for data consolidation from the of memory blocks. The controller is further configured to read a physical-to-logical address mapping table associated with the source block to determine a first logical group in the source block. The controller is further configured to load a first logical-to-physical address mapping table associated with the first logical group. The controller is further configured to identify, using the first logical-to-physical address mapping table, valid memory fragments of the source block that are associated with the first logical group. The controller is further configured to consolidate the identified valid memory fragments associated with the first logical group.

In some embodiments, the first logical-to-physical address mapping table includes a plurality of memory fragment entries that indicate memory fragment associated with the first logical group and corresponding memory blocks for each memory fragment. In some embodiments, the first logical-to-physical address mapping table includes 1024 memory fragment entries. In some embodiments, the controller is further configured to identify valid memory fragments by identifying memory fragments entries that indicate memory fragments corresponding to the source block. In some embodiments, the memory fragments include 4 kilobyte memory fragments. In some embodiments, the controller is further configured to group the identified valid memory fragments for the first logical group sequentially in a destination block. In some embodiments, the controller is further configured to read the physical-to-logical address mapping table associated with the source block to determine a second logical group in the source block and load a second logical-to-physical address mapping table associated with the second logical group. In some embodiments, the controller is further configured to, using the second logical-to-physical address mapping table, valid memory fragments of the source block that are associated with the second logical group and consolidate the identified valid memory fragments associated with the second logical group.

In some embodiments, a method for operating a memory system having a controller and blocks of memory includes selecting a source block for data consolidation from blocks of memory. The method further includes reading a physical-to-logical address mapping table associated with the source block to determine a first logical group in the source block. The method further includes loading a first logical-to-physical address mapping table associated with the first logical group, wherein the first logical-to-physical address mapping table includes memory fragment entries that identify memory fragments of the first logical group and corresponding memory blocks for each memory fragment. The method further includes determining, using the first logical-to-physical address mapping table, valid memory fragments associated with the first logical group in the source block by identifying memory fragments corresponding to the source block. The method further includes consolidating the determined valid memory fragments associated with the first logical group.

In some embodiments, consolidating the determined valid memory fragments includes grouping the determined valid memory fragments for the first logical group sequentially in a destination block. In some embodiments, the method further includes reading the physical-to-logical address mapping table associated with the source block to determine a second logical group in the source block and loading a second logical-to-physical address mapping table associated with the second logical group. In some embodiments, the method further includes determining, using the second logical-to-physical address mapping table, valid memory fragments associated with the second logical group in the source block by identifying memory fragments corresponding to the source block and consolidating the valid memory fragments associated with the second logical group.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module. In some embodiments, the controller 104 is implemented within the host 106 can be configured with hardware and/or firmware to perform the various functions described herein.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for data consolidation in a memory system, the method comprising:
selecting a source block for data consolidation from a plurality of memory blocks in the memory system;
reading a physical-to-logical address mapping table comprising a reverse group address table (RGAT) associated with the source block, and thereby determining a first logical group in the source block;
loading a first logical-to-physical address mapping table, comprising a first group address table (GAT), associated with the first logical group;
identifying, using logical numbers of logical groups included in the first logical-to-physical address mapping table, valid memory fragments of the source block that are associated with the first logical group; and
consolidating the identified valid memory fragments associated with the first logical group.

2. The method of claim 1, wherein
the first logical-to-physical address mapping table includes a plurality of memory fragment entries and, for each of the plurality of memory fragment entries, an indication of a corresponding memory block, and
the plurality of memory fragment entries included in the first logical-to-physical address mapping table are associated with the first logical group.

3. The method of claim 2, wherein the first logical-to-physical address mapping table includes 1024 memory fragment entries.

4. The method of claim 2, wherein the identifying, using logical numbers of logical groups included in the first logical-to-physical address mapping table, valid memory fragments of the source block that are associated with the first logical group includes identifying memory fragments entries that indicate memory fragments corresponding to the source block.

5. The method of claim 1, wherein the memory fragments include 4 kilobyte memory fragments.

6. The method of claim 1, wherein consolidating the identified valid memory fragments includes grouping the identified valid memory fragments for the first logical group sequentially in a destination block.

7. The method of claim 1, further comprising, reading the physical-to-logical address mapping table associated with the source block and thereby determining a second logical group in the source block and loading a second logical-to-physical address mapping table, comprising a second GAT, associated with the second logical group.

8. The method of claim 7, further comprising identifying, using logical numbers of logical groups included in the second logical-to-physical address mapping table, valid memory fragments of the source block that are associated with the second logical group and consolidating the identified valid memory fragments associated with the second logical group.

9. A memory system comprising:
a non-volatile storage having an array of memory blocks storing data that is associated with logical block address (LBA) addresses; and
a controller in communication with the memory blocks, the controller configured to:
select a source block for data consolidation from the of memory blocks;
read a physical-to-logical address mapping table, comprising a reverse group address table (RGAT), associated with the source block and thereby determine a first logical group in the source block;
load a first logical-to-physical address mapping table, comprising a first group address table (GAT), associated with the first logical group;
identify, using logical numbers logical groups included in the first logical-to-physical address mapping table, valid memory fragments of the source block that are associated with the first logical group; and
consolidate the identified valid memory fragments associated with the first logical group.

10. The memory system of claim 9, wherein:
the first logical-to-physical address mapping table includes a plurality of memory fragment entries and, for each of the plurality of memory fragment entries, an indication of a corresponding memory block; and
the plurality of memory fragment entries included in the first logical-to-physical address mapping table are associated with the first logical group.

11. The memory system of claim 10, wherein the first logical-to-physical address mapping table includes 1024 memory fragment entries.

12. The memory system of claim 10, wherein the controller is further configured to identify valid memory fragments by identifying memory fragments entries that indicate memory fragments corresponding to the source block.

13. The memory system of claim 9, wherein the memory fragments include 4 kilobyte memory fragments.

14. The memory system of claim 9, wherein the controller is further configured to group the identified valid memory fragments for the first logical group sequentially in a destination block.

15. The memory system of claim 9, wherein the controller is further configured to read the physical-to-logical address mapping table associated with the source block and thereby determine a second logical group in the source block and load a second logical-to-physical address mapping table, comprising a second GAT, associated with the second logical group.

16. The memory system of claim 15, wherein the controller is further configured to, using logical numbers of logical groups included in the second logical-to-physical address mapping table, valid memory fragments of the source block that are associated with the second logical group and consolidate the identified valid memory fragments associated with the second logical group.

17. A method for operating a memory system having a controller and blocks of memory, the method comprising:
selecting a source block for data consolidation from blocks of memory;
reading a physical-to-logical address mapping table, comprising a reverse group logical address table (RGAT), associated with the source block and thereby determining a first logical group in the source block;
loading a first logical-to-physical address mapping table, comprising a first group address table (GAT), associated with the first logical group, wherein:
the first logical-to-physical address mapping table includes a plurality of memory fragment entries and, for each of the plurality of memory fragment entries, an indication of a corresponding memory block, and
the plurality of memory fragments entries included in the first logical-to-physical address mapping table are associated with the first logical group;
determining, using logical numbers of logical groups included in the first logical-to-physical address mapping table, valid memory fragments associated with the first logical group in the source block by identifying memory fragments corresponding to the source block; and
consolidating the determined valid memory fragments associated with the first logical group.

18. The method of claim 17, wherein consolidating the determined valid memory fragments includes grouping the determined valid memory fragments for the first logical group sequentially in a destination block.

19. The method of claim 17, further comprising, reading the physical-to-logical address mapping table associated with the source block and thereby determining a second logical group in the source block and loading a second logical-to-physical address mapping table, comprising a second GAT, associated with the second logical group.

20. The method of claim 19, further comprising determining, using logical numbers of logical groups included in the second logical-to-physical address mapping table, valid memory fragments associated with the second logical group in the source block by identifying memory fragments corresponding to the source block and consolidating the valid memory fragments associated with the second logical group.
